(19) United States
(12) Patent Application Publication
(10) Pub. No.: US 2020/0146780 A1
(43) Pub. Date: May 14, 2020

(54) DENTAL TRACTION DEVICE

(71) Applicants: Yi-Wen Chen, New Taipei City (TW); Hsi-Yuan Lin, New Taipei City (TW)

(72) Inventors: Yi-Wen Chen, New Taipei City (TW); Hsi-Yuan Lin, New Taipei City (TW); Hao-Ming Chiu, New Taipei City (TW)

(21) Appl. No.: 16/186,611

(22) Filed: Nov. 12, 2018

(51) Int. Cl. A61C 7/16

(52) U.S. Cl. CPC A61C 7/16

(57) ABSTRACT

A dental traction device mainly comprises at least one seat-body set with a bonding-surface and a rod-body; wherein the bonding-surface and the rod-body are located at two different opposite sides; wherein the rod-body comprises a bending-portion and an extending-portion, which the bending-portion is connected on the seat-body to change the extension direction of the rod-body; wherein the extending-portion is connected on one end to extend the rod-body length, and one end of the extending-portion facing away from the bending-portion is set with a engaging-hooking piece; thereby, the seat-body can be adhered on the tooth of the user and then the elastic element is stuck and engaged on the engaging-hooking piece to cooperate with the extending-portion to generate a status of force moment; which will simultaneously move and rotate the teeth to be closer for each other, and so as to have the dual effects rapidly and conveniently.

### (a) TECHNICAL FIELD OF THE INVENTION

The present invention provides a dental traction device, and especially relates to a dental traction device having the dual effects of rapidly and conveniently moving and rotating the tooth.

### (b) DESCRIPTION OF THE PRIOR ART

Generally, teeth can be regarded as a person's facade; when everyone talks to each other, if they see a pair of disorganized teeth, they will have an impact on people's first impressions, and the first impression between people will often determine many key points. Therefore, modern people care about the care and cleanliness of their teeth.

The most common way to adjust the position and shape of teeth is to wear braces; where the braces are also divided into many kinds, and the more popular way is to use the rope body to pull to gradually change the position of the teeth.

However, sometimes the teeth may be skewed or the spacing is too large, so that just using the rope body to pull is not enough to correct; therefore an engaging-hooking rod is added to adjust. The problem is that this method can only be installed on the original braces, which is inconvenient in use.

### SUMMARY OF THE INVENTION

The main purpose of the present invention is to use the seat-body cooperating with the rod-body to quickly and conveniently achieve the dual effects of moving and rotating the teeth simultaneously.

In order to achieve the above-mentioned objectives, the main structure of the present invention comprises: at least one seat-body, a bonding-surface defined on the seat-body, a rod-body located at one side facing away from the bonding-surface, an engaging-hooking piece set at one end of the rod-body facing away from of the seat-body, and an elastic element stuck and engaged on the engaging-hooking piece; wherein the rod-body comprises a bending-portion and an extending-portion, which one end of the bending-portion is connected on the seat-body, and the extending-portion is connected with the other end of the bending-portion; wherein one end of the extending-portion facing away from the bending-portion is connected with the engaging-hooking piece; by using the above-mentioned structure, the user can adhere the seat-body on the tooth by the bonding surface; and the elastic element is stuck and engaged on the engaging-hooking piece; thereby, the pulling force generated by the elastic element cooperated with the engaging-hooking piece, rod-body, and the seat-body is used to transmit the pulling force to close the teeth with each other; and when pulling, the pulling force of the elastic element also uses the seat-body as an axis center to cooperated the rotation moment generated by the extension portion to rotate the tooth, therefore it also has the rotation power simultaneously; thereby, the bonding-surface can be used to directly adhere on the tooth to make the present invention has the convenient advantage and has the dual effects which can simultaneously move and rotate the tooth by cooperating the seat-body and the rod-body. With the above-mentioned technology, the present invention can break through the problem of the conventional braces which is inconvenient or has incomplete use effect, and so as to achieve the practicality and progressiveness having the above-mentioned advantages.

### BRIEF DESCRIPTION OF THE DRAWINGS

FIG. 1 is a stereoscopic diagram of the preferred embodiment of the present invention.

FIG. 2 is a stereoscopic diagram of the preferred embodiment of another perspective of the present invention.

FIG. 3 is a sticking schematic diagram of the preferred embodiment of the present invention.

FIG. 4 is a hitching schematic diagram of the preferred embodiment of the present invention.

FIG. 5 is a moving schematic diagram (1) of the preferred embodiment of the present invention.

FIG. 6 is a moving schematic diagram (2) of the preferred embodiment of the present invention.

FIG. 7 is a stereoscopic diagram of the other preferred embodiment of the present invention.

FIG. 8 is a using schematic diagram of the other preferred embodiment of the present invention.

FIG. 9 is a stereoscopic diagram of another preferred embodiment of the present invention.

FIG. 10 is a using schematic diagram of another preferred embodiment of the present invention.

FIG. 11 is a stereoscopic diagram of another preferred embodiment of the present invention.

FIG. 12 is a using schematic diagram of another preferred embodiment of the present invention.

FIG. 13 is a stereoscopic diagram of another preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

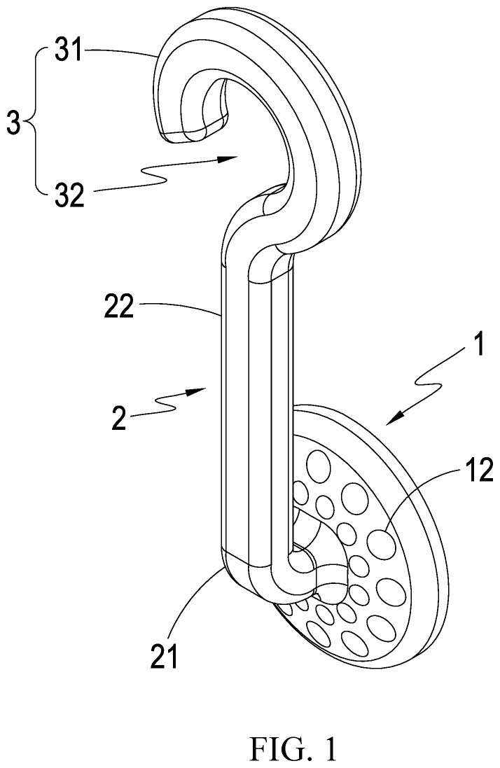

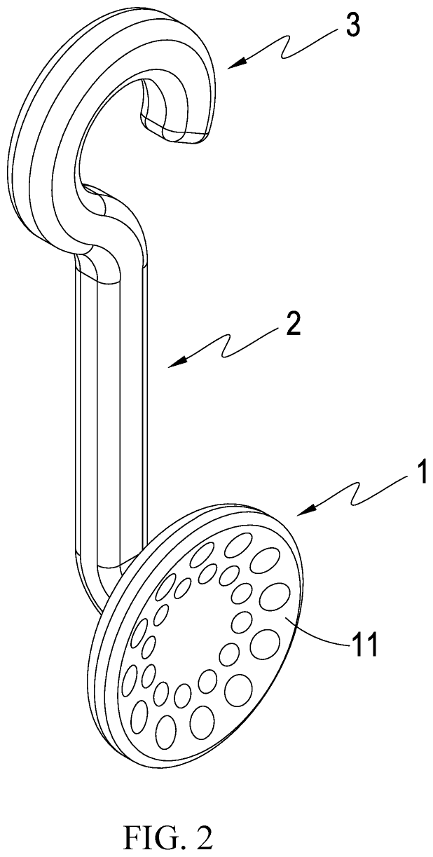

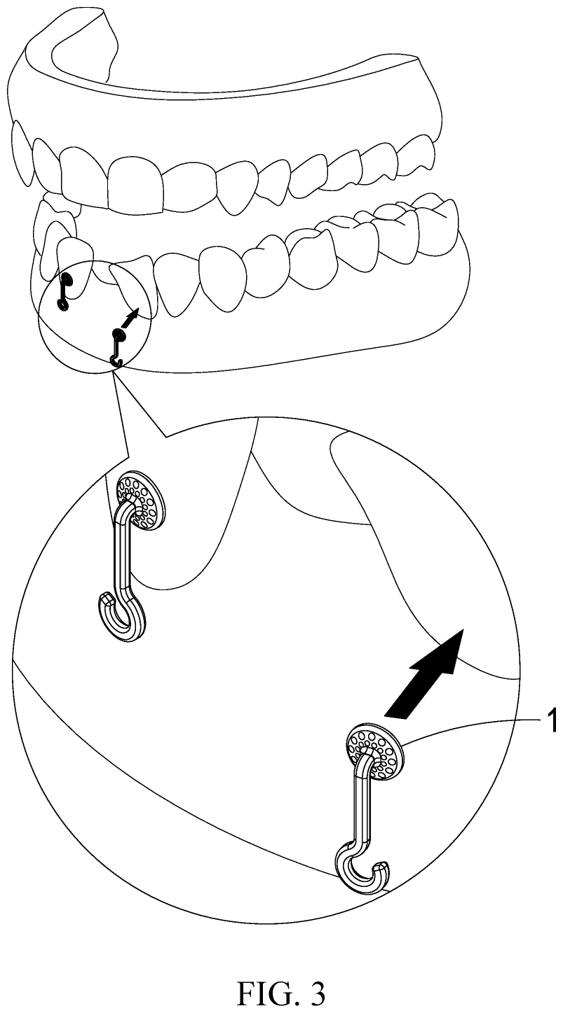

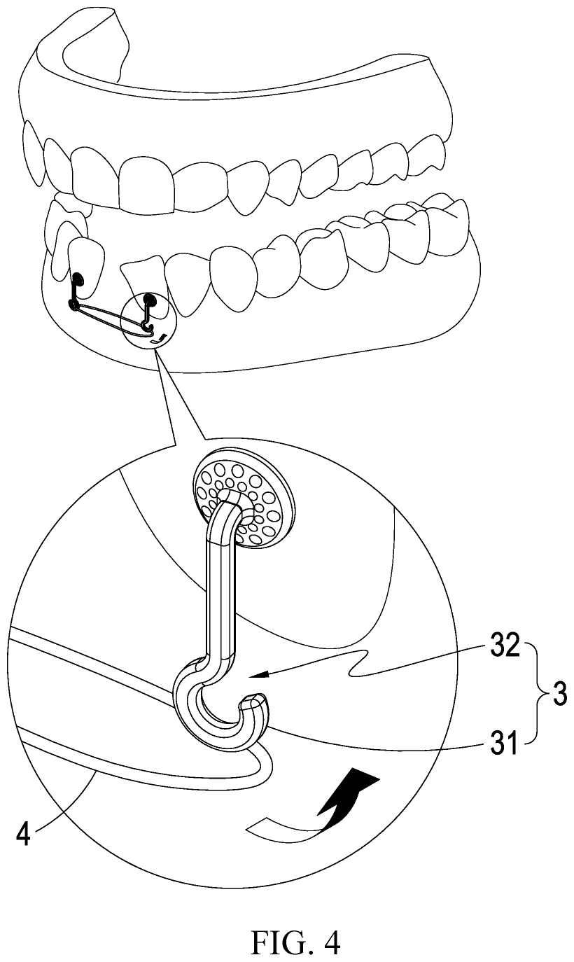

Please refer to FIG. 1 to FIG. 4, which are the stereoscopic diagram to the hitching schematic diagram of the preferred embodiment of the present invention; it can be clearly seen from the figures that the present invention comprises: a seat-body, a bonding-surface 11, a rod-body 2, an engaging-hooking piece 3, and an elastic element 4; wherein the bonding-surface is defined on the seat-body 1, and one end of the rod-body 2 is connected with the seat-body 1 and is located at one different side of the bonding-surface 11; wherein the rod-body 2 comprises a bending-portion 21 and an extending-portion 22, which one end of the bending-portion 21 is connected on the seat-body 1 and the other end is connected with the extending-portion 22; wherein one end of the extending-portion 22 facing away from the bending-portion 21 is connected with the engaging-hooking piece 3; thereby, the angle at which the rod-body 2 extends is changed via the bending-portion 21 and the distance between the engaging-hooking piece 3 and the seat-body 1 is extended via the extending portion 22; wherein the elastic element 4 is stuck and engaged on the engaging-hooking piece 3, which the elastic element 4 can be one of an elastic rubber ring or a spring, but it is not limited thereto.

In the present invention, the engaging-hooking piece 3 comprises a sticking-engaging portion 31 and an opening-portion 32; wherein the sticking-engaging portion 31 is connected on the extending-portion 22, and the opening-portion 32 is located at one side of the sticking-engaging portion 31; thereby, the elastic element 4 can enter via the opening-portion 32 to be stuck and engaged on the sticking-engaging portion 31; and wherein a plurality of through-holes 12 are set on the seat body 1, so that when the seat-body 1 is adhered on a tooth by the bonding surface 11 via an adhesive, the adhesive can flow out from the through-holes 12; which can allow the adhesion being more stable; but it is not limited, it also can be without the through-holes 12; and the material of the seat-body 1 can be one of metal or plastic, but it is not limited, it can be other types of materials.

With the above description, the structure of the present technology can be understood, and according to the corresponding cooperation of the structure, the advantage of having a quick and convenient movement and rotation effect can be achieved, and the detailed explanation will be described below.

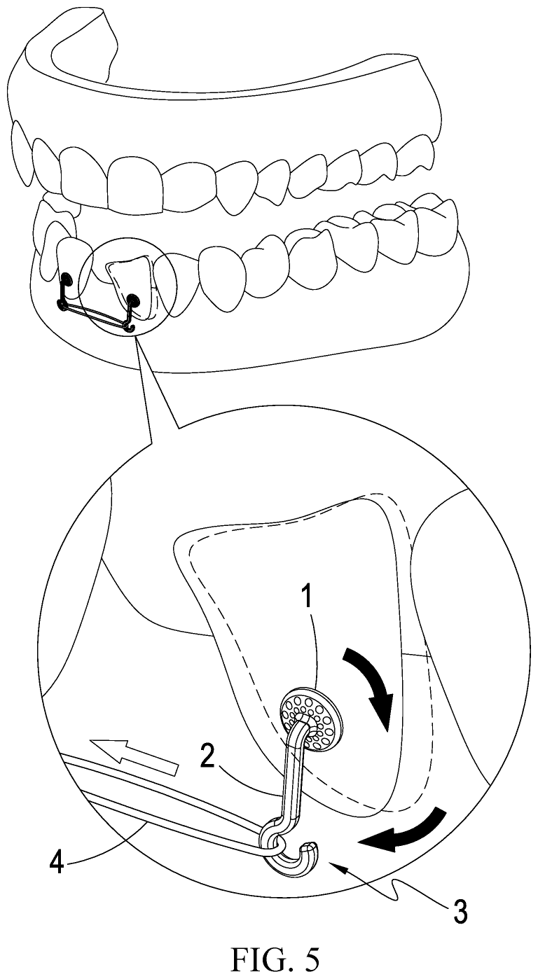

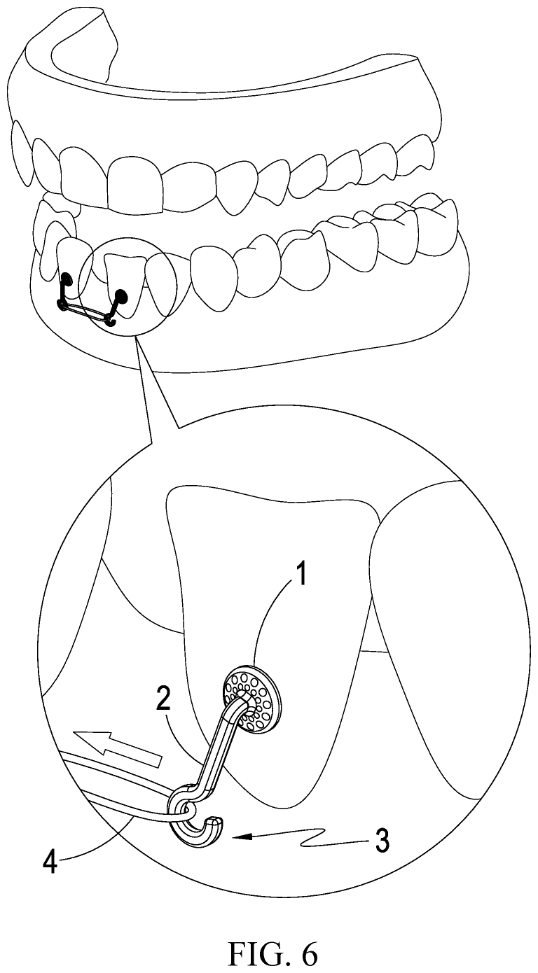

Please simultaneously refer to FIG. 1 to FIG. 6, which are the stereoscopic diagram to the moving schematic diagram (2) of the preferred embodiment of the present invention; when using the above-mentioned component structure to construct the present invention, it can be clearly seen from the figures that the user can use the adhesive to respectively adhere the seat-body 1 on each tooth by the bonding surface 11; and the excess adhesive will flow out from the through-holes 12; so that the seat-body 1 will be adhered more stable; then, the elastic element 4 is hitched on the sticking-engaging portion 31 via the opening-portion 32, whereby the elastic element 4 is stuck and engaged on the engaging-hooking piece 3; at this time, the elastic force of the elastic element 4 is transmitted to the teeth via the engaging-hooking piece 3, the rod-body 2, and the s seat-body 1, so that a pulling force will be generated to pull the teeth closer for each other; and since the elastic element 4 is stuck and engaged on the engaging-hooking piece 3; therefore the seat-body 1 is used as a circle center and the extension portion 22 is used as an axis to generate a rotation moment when the pulling force is transmitted; thereby, the teeth are rotated by the center of the seat-body 1, so that in addition to the teeth being close to each other to form a similar situation of closing-door, the moment of the tooth rotation can also be given; such that the tooth is rotated to a relatively normal state, and the seat-body 1 can be used by just being directly adhered on the tooth during use; it is not necessary to cooperate with other braces, thereby improving the convenience of use.

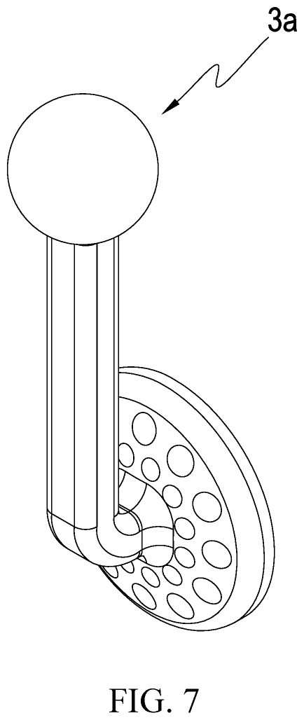

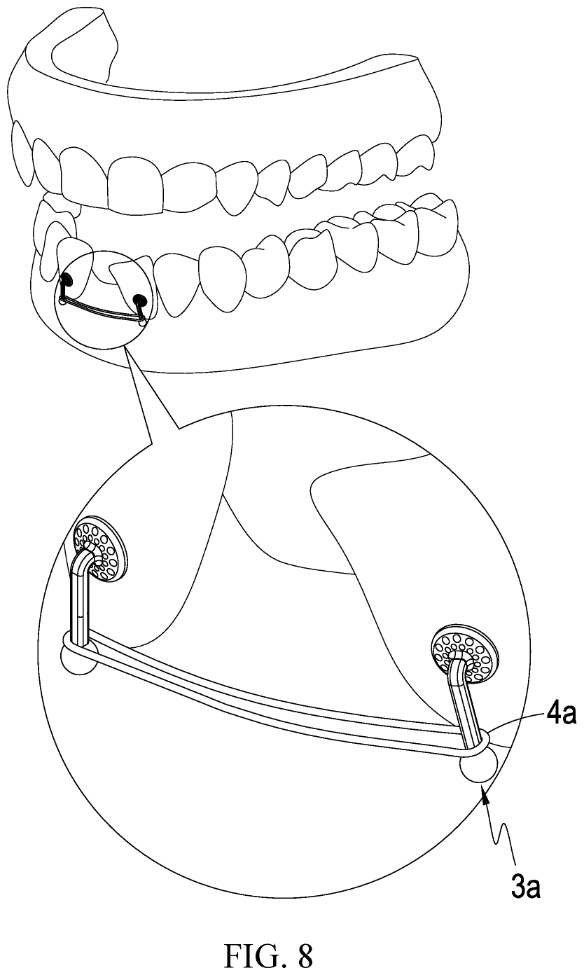

Please simultaneously refer to FIG. 7 and FIG. 8, which are the stereoscopic diagram and the using schematic diagram of the other preferred embodiment of the present invention; it can be clearly seen from the figures that this embodiment is similar to the above embodiment. The engaging-hooking piece 3a in this embodiment is a round-shape type, so that the elastic element 4a can be hitched on along the arc edge of the engaging-hooking piece 3 a; which makes the use more convenient, and the type of the engaging-hooking piece 3a is not limited.

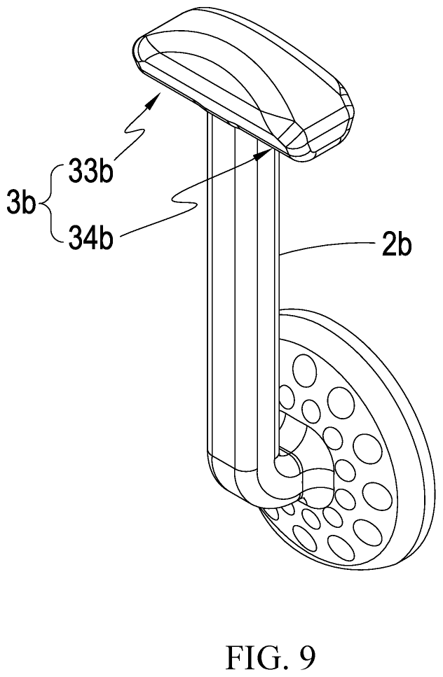

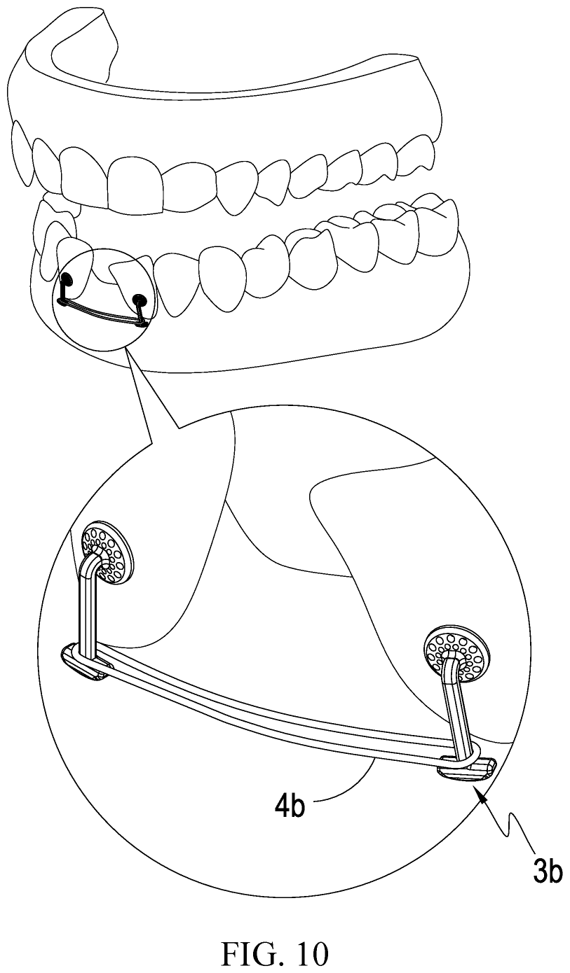

Please simultaneously refer to FIG. 9 and FIG. 10, which are the stereoscopic diagram and the using schematic diagram of another preferred embodiment of the present invention; it can be clearly seen from the figures that this embodiment is similar to the above embodiment. The engaging-hooking piece 3b of this embodiment comprises a first hooking-rod 33b and a second hooking-rod 34b; which the first hooking-rod 33b and the second hooking-rod 34b are connected to the rod-body 2b and are extended in the opposite directions; therefore, when the user needs to hitch the elastic element 4b, the first hooking-rod 33b or the second hooking-rod 34b can be selected to be hitched on; and the elastic element 4b can be hitched on without the necessity of turning the engaging-hooking piece 3b to match; therefore, the convenience of use is increased, and the type of the engaging-hooking piece 3b is not limited.

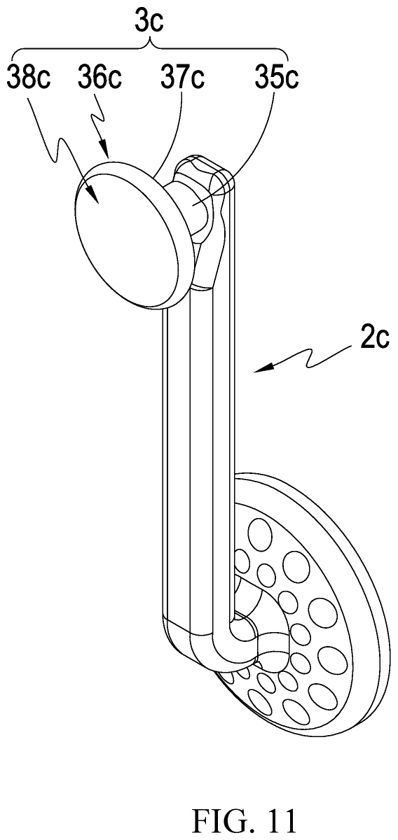

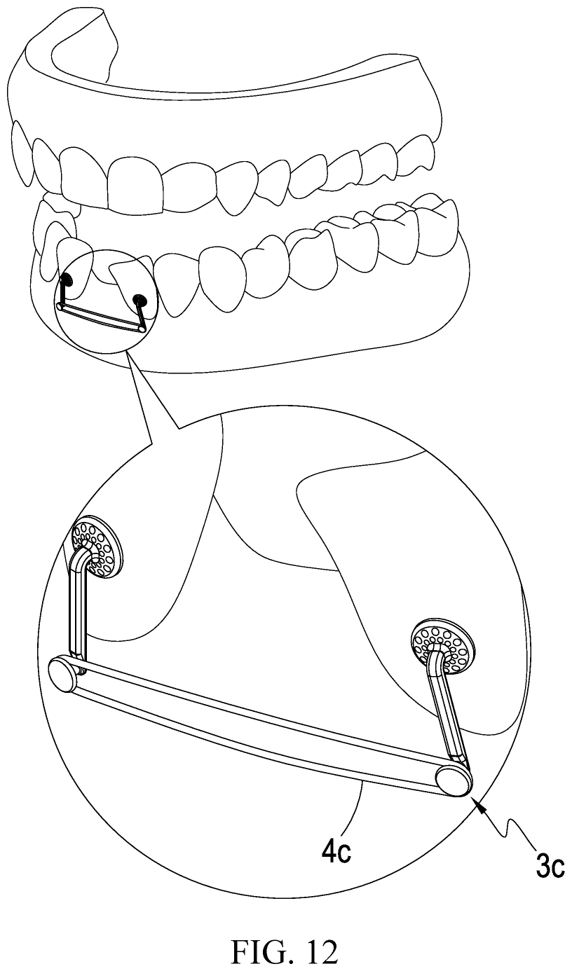

Please simultaneously refer to FIG. 11 and FIG. 12, which are the stereoscopic diagram and the using schematic diagram of another preferred embodiment of the present invention; it can be clearly seen from the figures that this embodiment is similar to the above embodiment. The engaging-hooking piece 3c of this embodiment comprises a tractive-body 35c, a blocking-stopping-body 36c, a plane-surface portion 37c, and an arc-portion 38c; wherein the tractive-body 35c is connected to the rod-body 2c and has a predetermined angle with the rod-body 2c; thereby, the tractive-body 35c is extended in a direction different from the rod-body 2c; wherein the blocking-stopping-body 36c is connected on the tractive-body 35c and the plane-surface portion 37c is formed at one side which the blocking-stopping-body 36c is adjacent to the tractive-body 35c; and the arc-portion 38c is formed at one side which the blocking-stopping-body 36c is facing away from the tractive-body 35c; thus when the elastic element 4c is hitched, the user can directly hitch the elastic element 4c on the blocking-stopping-body 36c along the position of the arc-portion 38c; and make the elastic element 4c engaged between the plane-surface portion 37c and the tractive-body 35c; therefore, when used, it is not necessary to adjust the direction of the engaging-hooking piece 3c; and the elastic element 4c can also be more easily hitched on the engaging-hooking piece 3c with the assistance of the arc-portion 38c, which makes the use more convenient, and the type of the engaging-hooking piece 3c is not limited.

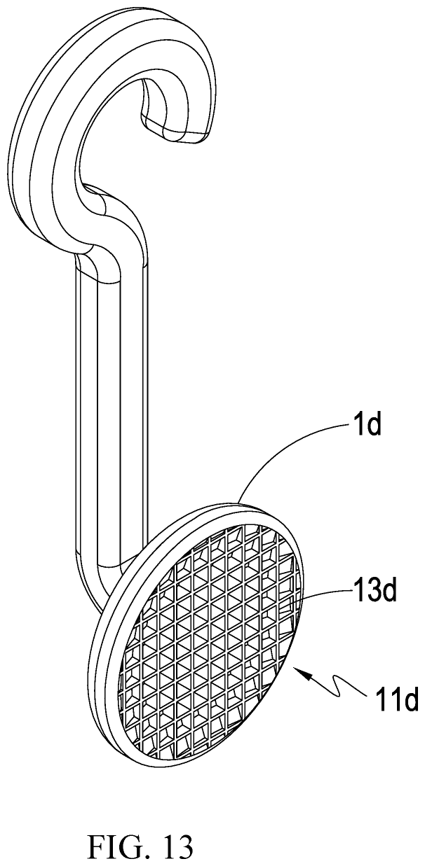

Please simultaneously refer to FIG. 13, which is the stereoscopic diagram of another preferred embodiment of the present invention; it can be clearly seen from the figure that this embodiment is similar to the above embodiment; only a plurality of mesh-rib-structures 13d are set on one side of the seat-body 1d adjacent to the bonding-surface 11d; so that the user can make the seat-body 1d more stable via the mesh-rib-structures 13d when it is adhered to the teeth.

Therefore, the key of the dental traction device of the present invention to improving the conventional techniques is lied in that: The present invention can be directly adhered to the tooth via the seat-body 1 without the need to cooperate with other mechanisms; so it can increase the convenience; and it has the dual effects which can simultaneously move and rotate the tooth via the rod-body 2, engaging-hooking piece 3, and the elastic element 4.

I claim:

1. A dental traction device, which mainly comprises:
at least one seat-body;
a bonding-surface defined on the seat-body;
a rod-body; wherein one end of the rod-body is located at one side which the rod-body is facing away from the bonding-surface and the rod-body comprises a bending-portion and an extending-portion; wherein one end of the bending-portion is connected on the seat-body, and the extending-portion is connected with one end of the bending-portion facing away from the seat-body;
an engaging-hooking piece set at one end of the extending-portion facing away from of the bending-portion; and
an elastic element stuck and engaged on one side of the engaging-hooking piece.

2. The dental traction device according to claim 1, wherein the seat-body is set with a plurality of through-holes.

3. The dental traction device according to claim 1, wherein the engaging-hooking piece comprises a sticking-engaging portion and an opening-portion; wherein the sticking-engaging portion is connected on the extending-portion and the opening-portion is located at one side of the sticking-engaging portion to provide the elastic element to enter and be stuck and engaged on the sticking-engaging portion.

4. The dental traction device according to claim 1, wherein the engaging-hooking piece comprises a first hooking-rod and a second hooking-rod; wherein the first hooking-rod and the second hooking-rod are both connected to the extending-portion and are extended in different directions.

5. The dental traction device according to claim 1, wherein the engaging-hooking piece is a round-ball type.

6. The dental traction device according to claim 1, wherein the engaging-hooking piece comprises a tractive-body, a blocking-stopping-body, a plane-surface portion, and an arc-portion; wherein one end of the tractive-body is connected with the extending-portion and the other end is connected with the blocking-stopping-body; wherein the plane-surface portion is defined at one side which the blocking-stopping-body is adjacent to the tractive-body; wherein the arc-portion is defined at one side which the blocking-stopping-body is facing away from the plane-surface portion.

7. The dental traction device according to claim 1, wherein at least one mesh-rib-structure is set on one side of the bonding-surface of the seat-body.

8. The dental traction device according to claim 1, wherein the material of the seat-body is one of plastic or metal.
